(19) United States
(12) Patent Application Publication
(10) Pub. No.: US 2011/0082730 A1
(43) Pub. Date: Apr. 7, 2011

(54) UNIFIED SUBSCRIPTION SYSTEM AND METHOD FOR REWARDING LOCAL SHOPPER LOYALTY AND PLATFORM FOR TRANSITIONING PUBLISHERS

(76) Inventors: Jon Karlin, Redmond, WA (US); Lee Wang, Kirkland, WA (US)

(21) Appl. No.: 12/796,619

(22) Filed: Jun. 8, 2010

Related U.S. Application Data
(63) Continuation-in-part of application No. 12/504,573, filed on Jul. 16, 2009.
Application No. 12/504,573 is a continuation-in-part of application No. 12/390,399, filed on Feb. 20, 2009.
Application No. 12/390,399 is a continuation-in-part of application No. 11/731,119, filed on Mar. 30, 2007.
(60) Provisional application No. 61/185,163, filed on Jun. 8, 2009.
(60) Provisional application No. 61/081,356, filed on Jul. 16, 2008.
(60) Provisional application No. 61/029,979, filed on Feb. 20, 2008.
(60) Provisional application No. 60/788,407, filed on Mar. 31, 2006.

(51) Int. Cl. G06Q 30/00

(52) U.S. Cl. 705/14.16

(57) ABSTRACT

A purchase-transaction-settled online consumer referral and reward system and method using real-time specific merchant sales information is provided for the advertising publishing industry. The system provides a pay per transaction platform that allows advertising publishers to monetize online and offline print media advertising by tracking and linking ad acceptance events to consummated consumer purchases and reward loyalty of consumers with subscription credits.

### CROSS-REFERENCE TO RELATED APPLICATIONS

This application claims priority to U.S. Provisional Application Ser. No. 61/185,163 filed Jun. 8, 2009. This application is a Continuation-in-Part of U.S. patent application Ser. No. 12/504,573 filed Jul. 16, 2009 which claims priority to U.S. Provisional Application Ser. No. 61/081,356 filed Jul. 16, 2008. This application is also a Continuation-in-Part of U.S. patent application Ser. No. 12/390,399 filed Feb. 20, 2009 which claims priority to U.S. Provisional Patent Application Ser. No. 61/029,979 filed Feb. 20, 2008. This application also is Continuation-in-Part of U.S. patent application Ser. No. 11/731,119 filed on Mar. 30, 2007 which claims priority to U.S. Provisional Application Ser. No. 60/788,407, filed on Mar. 31, 2006, all of which are incorporated herein by reference.

### COPYRIGHT NOTICE

This disclosure is protected under United States and International Copyright Laws. © 2006-2010 Caliber Data, Inc. All Rights Reserved. A portion of the disclosure of this patent document contains material which is subject to copyright protection. The copyright owner has no objection to the facsimile reproduction by anyone of the patent document or the patent disclosure after formal publication by the USPTO, as it appears in the Patent and Trademark Office patent file or records, but otherwise reserves all copyright rights whatsoever.

### TECHNICAL FIELD

A system and method for selling, promoting, collecting payment for and syndicating advertisements using an on-line system is provided in which a purchase transaction settled consumer referral and rewards system can be used. The system and method combine an online consumer destination and/or shopping strategy, an advertising submission and placement strategy, a sales/payment transaction tracking strategy, an advertisement syndication strategy, and a viral marketing strategy facilitated by integration with a purchase-based incentive reward component to capture consumer actions and, accordingly, a contingent fee advertising model.

### BACKGROUND

Caliber's platform enables a media industry in transition. Although media companies have been floundering in recent years, the global issue around professional journalism took center stage during Obama's first 100 days when he discussed the importance of the voice of media in our democracy.

Expense cuts and staff reductions that threaten the long term viability of professional media have come about because revenue cutbacks from major advertisers and classified categories have not yet been replaced with revenue from local retailers.

At the same time, other expenses related to subscriber and small advertiser churn (i.e. a measure of customer loss) continue to escalate. Meanwhile, community journalism is becoming more and more pervasive, gaining a foothold even though ‘news’ is passed without the filters of either expertise or accuracy.

In response, industry leaders are openly discussing how to bridge to a paid online content model without losing ground in their print products. But the challenge is considerable because the greatest growth opportunity lies in attracting online-only readers who have free news alternatives.

### BRIEF DESCRIPTION OF DRAWINGS

FIG. 1 is a schematic illustration of an embodiment of the system that generates Pay-Per-Transaction™ ads.

FIG. 2 is a further illustration of an embodiment of the system that generates Pay-Per-Transaction™ ads.

### DETAILED DESCRIPTION OF A PREFERRED EMBODIMENT

The present invention offers an online platform solution to professional media, providing them with a compelling new way to drive and monetize online and print subscriptions while generating new revenue from SMB penetration. The system promises publishers higher revenue, lower expense; the magic combination to free up dollars and ultimately help support a resurgence of professional journalism.

Embodiments of the invention are operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

In one embodiment a system and method is described as a contingent fee based advertising system provided by a service provider. The service provider can be, for example an ad publisher, who hosts the functionality of the service provider. The service provider can track a consumer's response to discrete sales offers made by merchant affiliated with the service provider. The service provider can also detect resulting sales transactions/purchases, made by the consumer and trigger a commission fee to the service provider, when the said purchase transaction is matched to a favorable response to an online ad published by the said merchant prior or in-time of the said purchase (i.e. an “ad acceptance event”). The commission fee paid to the service provider, pays for the ad placement after the sales transaction made by the consumer from an affiliated merchant is validated. Validation of the sales transaction consists of two parts, a consumer's discrete ad acceptance event and a resulting discrete sales transaction. Because the ad placement is not paid until a discrete sales transaction occurs and is validated, the risk is shifted from the merchant to the ad publisher. Additionally, a consumer loyalty payment can be made to the consumer based the validated sales transaction, for example a reward can in one embodiment can be a subscription credit to a merchant online or offline advertising vehicle.

### The Unified Subscription and Local Shopper Loyalty Platform

In one embodiment, the cash redemption process, provides the ideal loyalty program for the publishing industry. It replaces outdated initiatives with a turnkey, customer-friendly model. The system is more compelling than coupon programs, yet plays directly into the growing consumer trend to utilize discounts and cash-back rewards.

When a customer either begins or renews an online or print subscription, a Merchant-Funded Loyalty Program is immediately activated. Cash credits, applied directly to the consumer's credit card following an in-store purchase, more than offset the cost of a subscription or the incremental cost of online access. And traffic is driven directly to the publisher's website without the publisher or SMB risking substantial upfront investment.

The SMB/Publisher relationship that results is just as important as the Subscriber Loyalty Program. The Pay Per Transaction platform enables publishers to tap into this huge market segment (SMBs still represent only 20% of total ad spending) without the traditional ad barriers. It no longer matters if the retailer lacks a strong online presence or struggles with an uncertain ROI. With no upfront cost and reduced complexity of online ad placement, more local retailers will do business with more local media on a more frequent basis. Ultimately, this helps publishers leverage their online and offline sales forces through cross media selling. The system also lowers the cost of account acquisition by reducing churn.

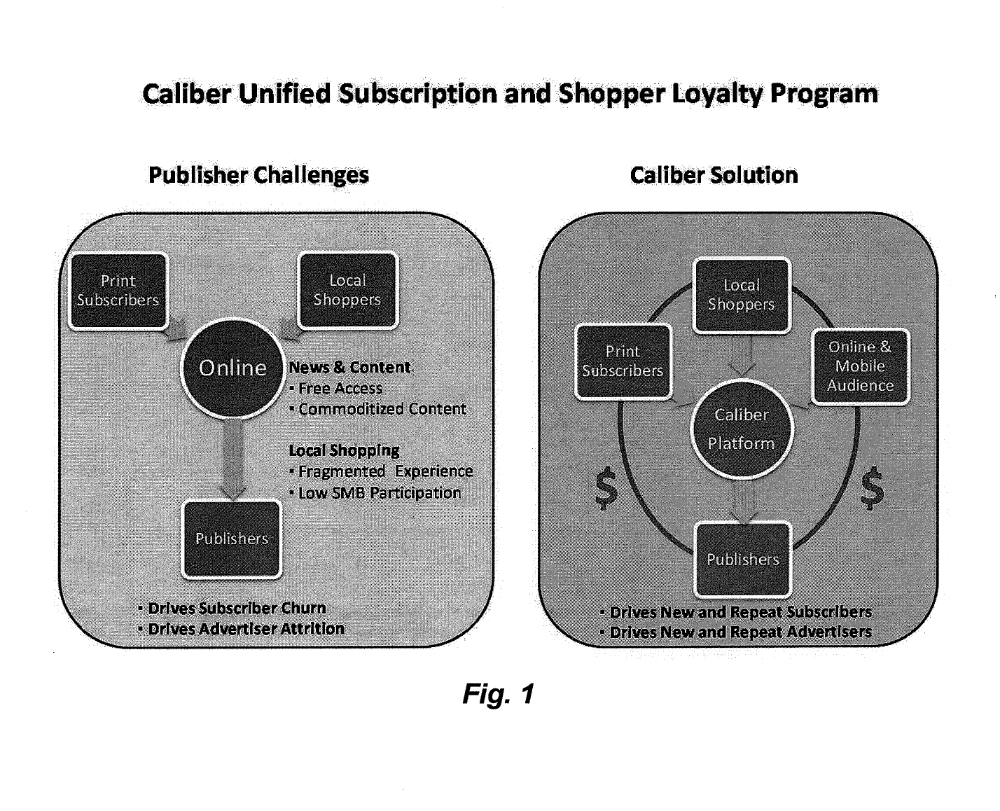

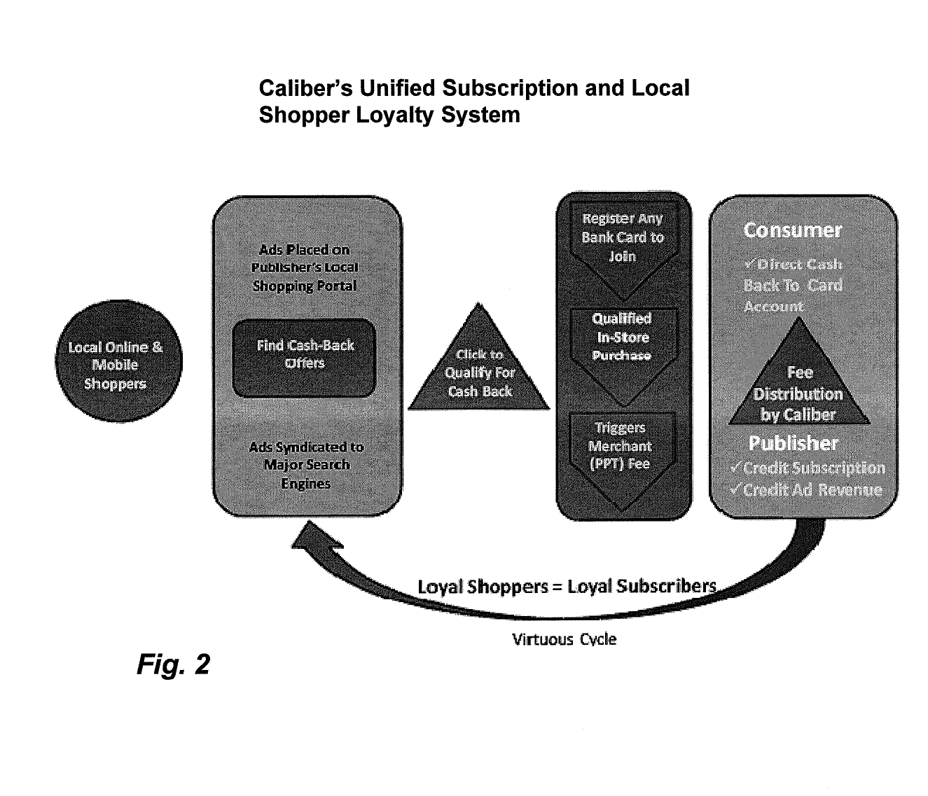

As schematically illustrated in FIGS. 1 and 2, an embodiment of the system Generates Pay-Per-Transaction™ Ads That Engage Local SMBs, Enabling Them to Post Time Constrained Cash Back Offers That Drive Local Consumer Shopping.

Single Point Registration of Bank Cards, (Credit and Debit), Provides Direct Cash Back Rewards to Local Consumers While Paying for and Promoting Online & Offline Subscriptions and Renewals.

The system Provides Direct Tracking of Online to Offline, (In-Store) Purchases, With Reporting and Notifications Tailored to Each Participant, Supports hyper-local targeting.

All good managers know that “you get what you measure”. The coup d′état in one embodiment of the present system is a comprehensive tracking and reporting system that serves each business partner. There is a dashboard for the merchant that gives the business the opportunity to monitor ad performance, tweak offers, target them to high-value customers, and measure the results of one campaign against another. There is also a media dashboard that gives the publisher the opportunity to view activity by salesperson, by publication, by advertiser or by geography. When hyper-local content in the form of qualified merchant reviews and local to local advertising is combined with the cross-promotional strength and bundling opportunities of the publisher's own products, the competitive advantage is virtually untouchable. Take it to market by empowering the largest feet-on-the street sales force in the United States, use cross media selling (offline to online and online to offline), and it becomes downright viral.

While the foregoing has been with reference to a particular embodiment of the invention, it will be appreciated by those skilled in the art that changes in this embodiment may be made without departing from the principles and spirit of the invention, the scope of which is defined by the appended claims.

The embodiments of the invention in which an exclusive property or privilege is claimed are defined as follows:

1. A computer implemented system for tracking and reporting offline sales transactions comprising:
an online advertising system;
a computing device comprising:
a memory;
a computer processor;
a service provider component associated with the online advertising system and further comprising a merchant unit, a transaction unit and a consumer unit;
wherein the merchant unit, transaction unit, and consumer unit of the service provider component each contain instructions stored in the memory, that are configured, when executed on the computer processor, to perform a method comprising:
receiving from the online advertising system associated with the service provider component, a sales offer from a particular merchant to a consumer;
tracking a plurality of offline sales transactions;
validating each offline sales transaction to determine if the sales transaction is a validated referral sales transaction for the particular merchant;
charging a commission fee for the validated referral sales transaction to the particular merchant; and
rewarding the consumer for the validated referral sales transaction with a subscription credit.
